(19) United States
(12) Patent Application Publication
(10) Pub. No.: US 2004/0027210 A1
(43) Pub. Date: Feb. 12, 2004

(54) Waveguide transition and port structure capable of coupling to two orthogonal transverse orientations

(76) Inventors: Amiee Chan, Vancouver (CA); Hendrik Albertus Thiart, Burnaby (CA); Christopher Michael Senger, Burnaby (CA); Sasa T. Trajkovic, Burnaby (CA); David R. Carter, Richmond (CA)

Correspondence Address: Vermette & Co., 200 Granville Street, Suite 230, Box 40 Granville Square, Vancouver, BC, V6C 1S4, CA

(21) Appl. No.: 10/212,753

(22) Filed: Aug. 7, 2002

(51) Int. Cl. H01P 1/165

(52) U.S. Cl. 333/21 A; 333/248

(57) ABSTRACT

The present invention is a waveguide transition and port structure, comprised of two distinct rectangular waveguide sections, with one section angularly displaced with respect to the other by 45 degrees about a common longitudinal axis. The orientation of the two waveguide sections enables the waveguide transition and port structure to rotate a polarized signal by 45 degrees such that, when coupled to an external device, as part of an antenna or other receiving or transmitting apparatus, either vertical or horizontal polarization of the signal can be effected with equal degrees of efficiency and without the need to change or reorient components, such as waveguides or twists.

### FIELD

The present invention relates to the field of microwave communication systems, and in particular to satellite communications signals.

### BACKGROUND OF THE INVENTION

In microwave communications systems, either terrestrial or satellite, the microwave energy can exist in a number of different orientations. Two principal orientations in which such energy can exist are circular and linear. This invention deals specifically with the linear orientation. In the linear orientation, there are two distinct polarizations, commonly referred to as horizontal and vertical.

In a typical antenna structure, the feed assembly consists of a feedhorn with a circular waveguide connector and a circular-to-rectangular waveguide transition, the rectangular end of which is connected to a transmit and receive apparatus. The orientation of the rectangular flange of the circular-to-rectangular waveguide transition with respect to the earth's surface determines whether vertical or horizontal polarization is effected.

By necessity, the required polarization is often determined subsequent to the physical design and placement of the transmit and receive apparatus of the station. In addition, it may be necessary to change the polarization subsequent to the initial setting of the polarization. In the prior art, a change of polarization has been accomplished by waveguide sections commonly known as twists. Twists typically consist of a section of rectangular waveguide, which has been physically twisted, such that the dominant mode at one end of the rectangular waveguide is angularly displaced by 90 degrees with respect to the other end of the rectangular waveguide. A disadvantage of using twists is that, in order to change the polarization of signals passing through a device, such as an antenna or feed assembly, the 90-degree twist must be replaced with a straight section of waveguide, or vice versa. In other words, the device must be reconfigured to change the polarization of the signals. A further disadvantage of the prior art is the requirement for the twists to be several wavelengths long, in order to preserve the field and to avoid reflections.

Alternative forms of such twists have been proposed in the prior art. Instead of effecting a continuous mechanical twist of a section of waveguide, a step or series of steps have been employed, with appropriate matching or tuning structures to effect a transition from one orientation to another. By this means, the complexities of forming a continuous mechanical twist are overcome, at the expense of complex tuning arrangements.

Further, in the prior art, thin plates have been used at the junction of two orthogonally displaced waveguides to effect a coupling between such waveguides. However, this approach does not eliminate the aforementioned problem of needing to replace the straight section of waveguide by the stepped twist, when a change in polarization is required.

It is an object of this invention to provide a permanently located waveguide transition and port structure for permitting a 90-degree rotation of microwave energy without the need to remove or add angular waveguide matching sections.

### SUMMARY OF THE INVENTION

The present invention provides a waveguide structure intended to be permanently located at the interface between the transmitting or receiving apparatus, and the antenna feed assembly. It is a feature of this invention that the external waveguide connecting to this device can be attached directly to the device interface without the need for any other intervening waveguide section to accommodate both orthogonal orientations of the connecting external waveguide or feed assembly. In essence, a universal rectangular waveguide flange is provided by the device.

In order to achieve this, a first waveguide section with rectangular cross section is joined to a second waveguide of identical cross section. The second waveguide section is set at a angle of 45 degrees with respect to the orientation of the first waveguide cross section when rotated on the shared longitudinal axis of both waveguide sections. The length of each section is determined by the center frequency of the band of frequencies to be transmitted through the waveguide sections.

The open end of the first waveguide section provides the interface to the fixed transmit or receive apparatus. This interface is of the same polarization and orientation as the transmit or receive apparatus. The open end of the second waveguide section is at 45 degrees with respect to both of the two possible external polarizations. Since 45 degrees is the mid-point between a normal connection of 0 degrees, and an orthogonal connection at 90 degrees, the degree of match is equal for both orthogonal polarizations.

The waveguide transition and port structure is electrically functional for either of two connection options without the requirement for any additional waveguide adapter structures, such as twists. This eliminates extra material and assembly cost, and permits a choice of either polarization, through appropriate orientation of a feed assembly.

### BRIEF DESCRIPTION OF THE DRAWINGS

Many objects and advantages of the present invention will be apparent to those of ordinary skill in the art when this specification is read in conjunction with the attached drawings wherein like reference numerals are applied to like elements and wherein:

FIG. 1 is a perspective view of the waveguide transition and port structure as a stand-alone device;

FIG.2 is a plan view of the waveguide transition and port structure, indicating the 45-degree displacement; and

FIG. 3 shows the external interface of the waveguide transition and port structure in an embodiment wherein the waveguide transition and port structure is an integral part of the station equipment.

### DETAILED DESCRIPTION OF THE INVENTION

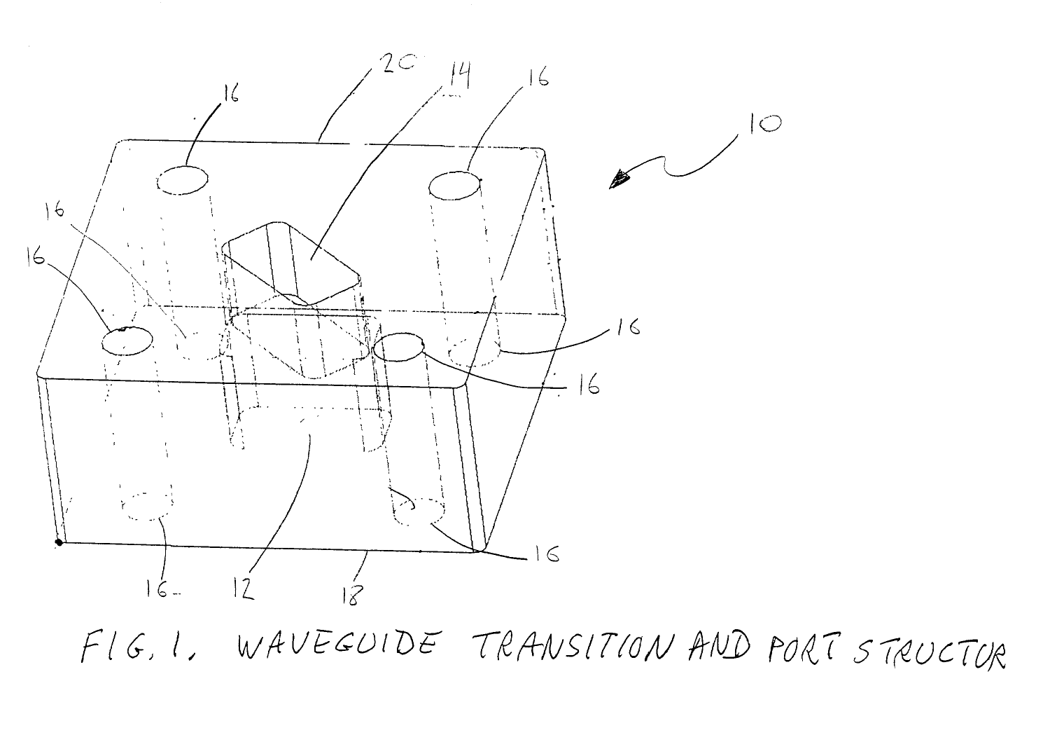

Referring to FIG. 1, the waveguide transition and port structure 10 is shown having a first waveguide section 12. A second waveguide section 14 connects directly to the first waveguide section 12 with an angular displacement in the transverse plane of 45 degrees. The waveguide transition and port structure 10 has mounting holes 16, symmetrically about the central axis of the waveguide sections 12, 14 so that the waveguide transition and port structure 10 can be connected in either of two 90-degree orientations.

The first waveguide section 12 is open-ended at equipment flange 18 for receipt of the microwave energy from the transmit or receive apparatus (not shown). The second waveguide section 14 is open-ended at external flange 20 for connection to an external waveguide (not shown) or alignment with a feed assembly (not shown).

The waveguide transition and port structure 10 requires no internal tuning means, however the axial length of first waveguide section 12, and the axial length of second waveguide section 14 are determined such that maximum energy transfer occurs at a specific frequency. While the bandwidth of such energy transfer is inherently narrow, it is sufficiently wide to accommodate the bandwidths normally encountered in microwave or satellite communications. The inner surfaces of first and second waveguide sections 12 and 14 are highly conductive at the microwave frequencies of operation.

The mounting holes 16 are identically positioned at the equipment flange 18 and external flange 20 ports. Further, the mounting holes 16 are symmetrical with respect to the central axis of the waveguide transition and port structure 10, which enables an external waveguide (not shown) to be connected to the external flange 20 in either of two 90-degree orientations in relation to the first waveguide section 12.

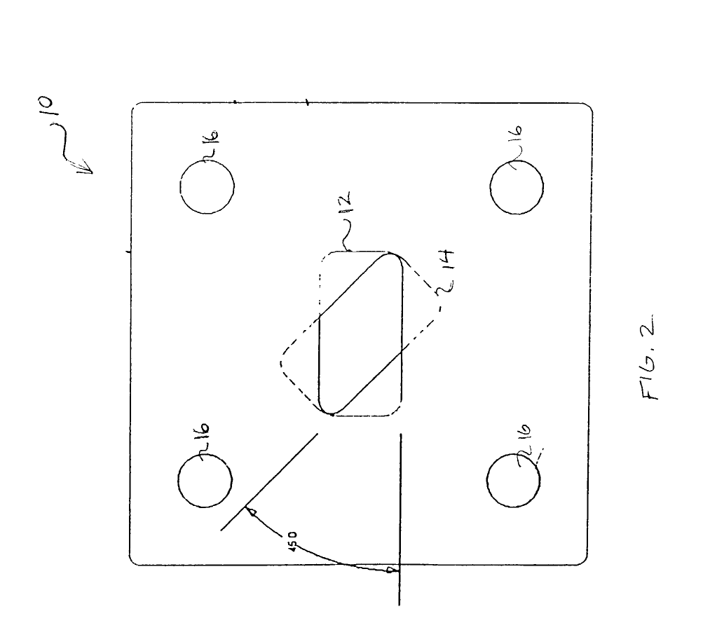

Referring to FIG. 2, the 45-degree displacement of second waveguide section 14 with respect to first waveguide section 12 is shown.

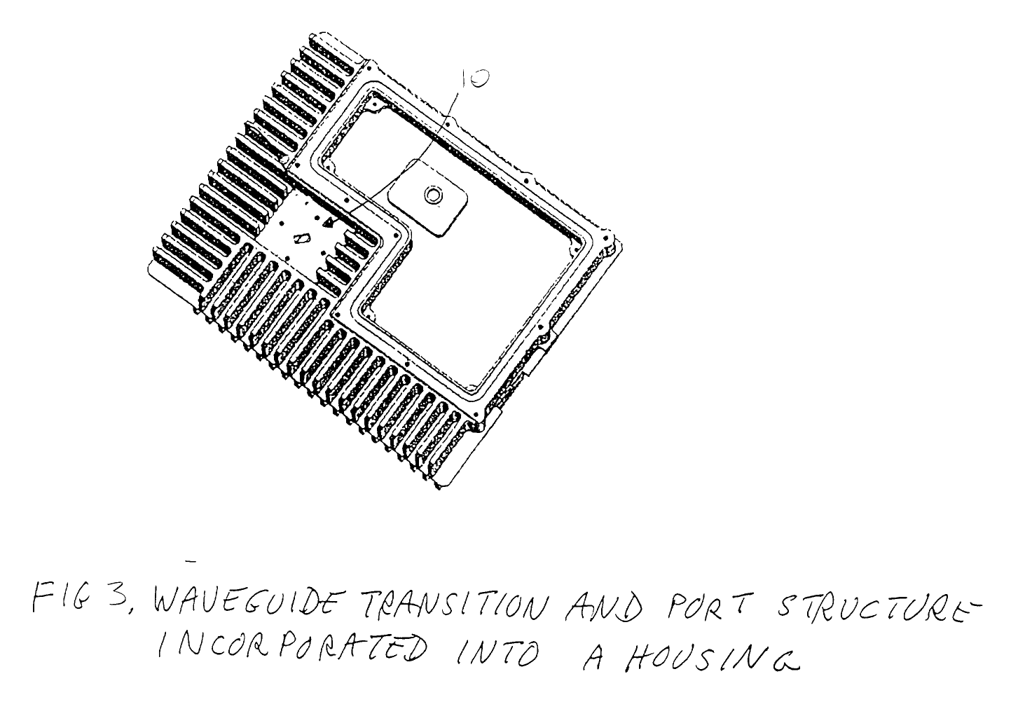

Although FIG. 1 and 2 show the waveguide transition and port structure 10 as a stand-alone structure, the waveguide transition and port structure 10 may be incorporated into a housing or casing 20, as shown in FIG. 3. The waveguide transition and port structure 10 shown in FIG. 3 is constructed as described above.

Although the waveguide sections 12 and 14 are described as rectangular, the waveguide sections may be of square or elliptical shape of any size appropriate for the frequency band of interest.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to the description. It is therefore contemplated that the appended claims will cover any such modifications or embodiments as fall within the true scope of the invention.

What is claimed is:

1. A waveguide transition and port structure, comprising a first waveguide section and a second waveguide section, wherein a first end of said first waveguide section is connected to a first end of said second waveguide section, said first and second waveguide sections having a common central longitudinal axis, wherein said second waveguide section is rotated 45 degrees about said central longitudinal axis with respect to said first waveguide section, wherein a cross-section of said first waveguide section is identical to a cross-section of said second waveguide section, and wherein said waveguide transition and port structure is open at both ends, said waveguide transition and port structure operative to rotate an incident polarized signal by 45 degrees.

2. The waveguide transition and port structure of claim 1, further comprising an equipment flange at a second end of said first waveguide section and an external flange at a second end of said second waveguide section, said equipment flange for coupling to one of a transmit apparatus and a receive apparatus and said external flange for coupling to one of an external waveguide and a feed assembly.

3. The waveguide transition and port structure of claim 1, wherein said cross sections are rectangular.

4. The waveguide transition and port structure of claim 2, further comprising an external rectangular waveguide, wherein said first waveguide section is aligned with said external rectangular waveguide in one of a dominant transverse mode and an othogonally displaced mode.

5. The waveguide transition and port structure of claim 1, wherein said first and second waveguide sections each have a length determined by the frequency to be transmitted through said first and second waveguide sections.

6. The waveguide transition and port structure of claim 1, wherein said waveguide transition and port structure is integrated into a housing.

7. The waveguide transition and port structure of claim 2, further comprising mounting holes in said external and equipment flanges, said mounting holes operative to couple said waveguide transition and port structure to an antenna feed assembly.

8. The waveguide transition and port structure of claim 2, further comprising mounting holes in said external and equipment flanges, said mounting holes operative to couple said waveguide transition and port structure to one of a transmitting apparatus and a receiving apparatus.

9. The waveguide transition and port structure of claim 7, wherein said mounting holes are symmetrically positioned about said first and second waveguide sections.

10. The waveguide transition and port structure of claim 8, wherein said mounting holes are symmetrically positioned about said first and second waveguide sections.
